(19) United States
(12) Patent Application Publication
(10) Pub. No.: US 2007/0133565 A1
(43) Pub. Date: Jun. 14, 2007

(54) Content packet transmission control method in mobile communication network supporting multimedia broadcast/multicast service

(76) Inventors: Eun-Hee Hyun, Daejeon-city (KR); Han-Jun Yoon, Dae-jeon-city (KR); Cheol-Hye Cho, Dae-jeon-city (KR); Young-Jick Bahg, Dae-jeon-city (KR)

Correspondence Address: LADAS & PARRY LLP, 224 SOUTH MICHIGAN AVENUE, SUITE 1600, CHICAGO, IL, 60604, US

(21) Appl. No.: 11/509,453

(22) Filed: Aug. 24, 2006

(30) Foreign Application Priority Data
Dec. 9, 2005 (KR) 10-2005-0120840

(51) Int. Cl. H04L 12/56; H04L 12/28

(52) U.S. Cl. 370/395.52

(57) ABSTRACT

A content packet transmission control system in a mobile communication network supporting a multimedia broadcast/multicast service (MBMS) includes a broadcast/multicast service center (BM-SC) performing an inter-working operation with a gateway general packet radio service support node (GGSN) and managing the MBMS so that contents may be broadcasted/multicasted to a plurality of user terminals, and a content provider (CP)/multicast broadcast (MB) source server providing contents of an internal CP or contents of an external CP according to a broadcasting schedule of each MBMS. When the user terminal using a predetermined MBMS leaves a service area or requests to stop the service, the content packet transmission control system stops transmitting corresponding service contents, and transmits a service packet to a new user terminal requesting the service and the user terminal coming back to the service area.

### CROSS-REFERENCE TO RELATED APPLICATION

This application claims priority to and the benefit of Korean Patent Application No. 10-2005-0120840 filed in the Korean Intellectual Property Office on Dec. 9, 2005, the entire contents of which are incorporated herein by reference.

### BACKGROUND OF THE INVENTION

(a) Field of the Invention

The present invention relates to a system for controlling an operation for transmitting a content packet in a mobile communication network that supports a multimedia broadcast/multicast service (MBMS), and a method thereof. More particularly, the present invention relates to a system for controlling an operation for transmitting a content packet in a mobile communication network that supports a multimedia broadcast/multicast service (MBMS), so that loads of the MBMS that are concentrated at a proxy node of a broadcast/multicast service center (BM_SC) in the mobile network may be reduced.

(b) Description of the Related Art

A multimedia broadcast/multicast service (MBMS) is transmitted by broadcasting or multicasting a multimedia contents packet from a content provider (CP)/multicast broadcast (MB) source server, which is a data source, to a plurality of user terminals through a mobile communication network. In such a point-to-multipoint service, resources of the mobile communication network may be saved since the same service is transmitted to the plurality of user terminals by broadcasting/multicasting MBMS contents from the CP/MB source server once. The MBMS is used in wireless communication network systems including a wideband code division multiple access (WCDMA) network and a global system for mobile communication (GSM) phone network. In a method for transmitting MBMS data, contents are transmitted from a data supply source, are transmitted in a service control network, are transmitted in a wireless network supporting a service area having a user terminal, and are then received by the user terminal.

However, a large amount of traffic will be expected to be transmitted as the variety of MBMSs and the number of broadcasting channels are increased. In addition, to transmit the large amount of traffic to the plurality of user terminals through the mobile communication network (e.g., the WCDMA network), broadcast multimedia contents are required to be transmitted from the CP/MB source server through a broadcast/multicast service center (BM-SC) that is connected to a gateway general packet radio service support node (GGSN).

The BM-SC that is connected to the GGSN functions as a packet network access point, and provides the MBMS for providing broadcast/multimedia content traffic to the plurality of user terminals through the mobile communication network.

However, once the MBMS is started, the BM-SC that is connected to an internal CP/MB source server or an external CP/MB source server of the BM-SC receives traffic packets for a corresponding service from the internal or external CP/MB source server. Finally, a proxy function of the BM-SC, the proxy function for distributing the packets, determines whether the packets are transmitted to the GGSN.

Therefore, in the MBMS service, since the content traffic is generated by a plurality of CP/MB source servers and is concentrated on the BM-SC, there is a problem in that an overload for processing the content traffic occurs on the BM-SC and a network traffic load occurs between the BM-SC and the CP/MB source servers.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a content packet transmission control system and a method thereof in a 3^{rd} generation partnership project (3GPP) mobile communication network (e.g., a wideband code division multiple access (WCDMA) network) for stably providing a multimedia broadcast/multicast service (MBMS), protecting resources, and reducing traffic load that is unnecessarily concentrated on a proxy node of a broadcast/multicast service center (BM-SC) since packets are transmitted by determining whether there is a service user terminal when the BM-SC that is performing an inter-working operation with gateway general packet radio service support nodes (GGSN) starts to transmit actual MBMS contents.

An exemplary content packet transmission control system according to an embodiment of the present invention in a mobile communication network (e.g., a wideband code division multiple access (WCDMA) network) supporting a multimedia broadcast/multicast service (MBMS) and including a universal mobile telecommunications network terrestrial radio access network (UTRAN) having a plurality of Node Bs and a plurality of wireless network controllers (RNC), and a core network (CN) having a plurality of gateway general packet radio service support nodes (GGSN) connected to a plurality of serving gateway general packet radio service support nodes (SGSN) providing packet services, includes a BM-SC and a content provider (CP)/multicast broadcast (MB) source server.

The BM-SC performs an inter-working operation with the GGSN, and controls and manages the MBMS so that MBMS service contents are broadcasted/multicasted to a plurality of user terminals through a distribution tree formed by below level nodes of the GGSN. The CP/MB source server provides contents of an internal content provider (CP) and contents of an external CP connected to the Internet according to a broadcasting schedule predetermined for each MBMS.

According to an exemplary content packet transmission control method in a mobile communication network (e.g., a wideband code division multiple access (WCDMA) network) including a universal mobile telecommunications network terrestrial radio access network (UTRAN) having a plurality of Node Bs and a plurality of wireless network controllers (RNC), a core network (CN) having a plurality of gateway general packet radio service support nodes (GGSN) connected to a plurality of serving gateway general packet radio service support nodes (SGSN) providing packet services, and a broadcast/multicast service center (BM-SC) connected to the GGSN to control and manage a multimedia broadcast/multicast service (MBMS), it is determined whether there is a user terminal registered to receive the corresponding MBMS when a service scheduler of the BM-SC detects that an MBMS session at a service start time is started, a service session establishment process is triggered by the BM-SC and is performed by the GGSN when there is a user terminal waiting to receive the corresponding MBMS, the MBMS session is started, an MBMS content packet is generated by a session and transmission function of the BM-SC, the generated MBMS content packet is transmitted to a proxy and transport node of the BM-SC that is performing an inter-working operation with the GGSN, the MBMS content packet is transmitted to the GGSN by the proxy and transport node of the BM-SC, and the MBMS content packet is multicasted/broadcasted to a plurality of user terminals that are waiting for the corresponding MBMS through a designated distribution tree path with below level nodes of the GGSN.

According to another exemplary content packet transmission control method in a mobile communication network (e.g., a wideband code division multiple access (WCDMA) network) including a universal mobile telecommunications network terrestrial radio access network (UTRAN) having a plurality of Node Bs and a plurality of wireless network controllers (RNC), a core network (CN) having a plurality of gateway general packet radio service support nodes (GGSN) connected to a plurality of serving gateway general packet radio service support nodes (SGSN) providing packet services, and a broadcast/multicast service center (BM-SC) connected to the GGSN to control and manage a multimedia broadcast/multicast service (MBMS), it is determined whether there is a user terminal registered to receive the corresponding MBMS when a service scheduler of the BM-SC detects that an MBMS session at a service start time is started, a service content delivery request message including an MBMS identifier (Service ID) and user join information (JoinedUserInd parameter) on a user terminal waiting to receive the MBMS is transmitted to an external content provider (CP), and a user join indication message including the MBMS identifier (Service ID) and updated user join information (JoinedUserInd parameter) is transmitted to the corresponding external CP by the BM-SC when there is a new user terminal waiting to receive the MBMS.

According to a further exemplary content packet transmission controlling method in a mobile communication network (e.g., a wideband code division multiple access (WCDMA) network) including a universal mobile telecommunications network terrestrial radio access network (UTRAN) having a plurality of Node Bs and a plurality of wireless network controllers (RNC), a core network (CN) having a plurality of gateway general packet radio service support nodes (GGSN) connected to a plurality of serving gateway general packet radio service support nodes (SGSN) providing packet services, and a broadcast/multicast service center (BM-SC) connected to the GGSN to control and manage a multimedia broadcast/multicast service (MBMS), a) an external CP receives a service content delivery request message from the BM-SC, b) the external CP receives a user join indication message including a service identifier (Service ID) and updated user join information (JoinedUserInd) from the BM-SC and transmits contents for the corresponding MBMS when there is a user terminal waiting to receive the MBMS, c) the external CP generates a content packet for the corresponding MBMS, d) it is determined whether there is a user terminal waiting for receiving the corresponding MBMS with reference to the user join information, e) the generated content packet is transmitted to a proxy node of the BM-SC and the content packet is broadcasted/multicasted to a plurality of user terminals waiting for receiving the corresponding MBMS through the proxy node performing an inter-working operation with the GGSN, and f) a service contents delivery complete message including the Service ID informing that service transmission is complete is transmitted to the BM-SC.

### BRIEF DESCRIPTION OF THE DRAWINGS

FIG. 1 shows a schematic diagram of a configuration of a system for providing the MBMS based on a 3^{rd} generation partnership project (3GPP) mobile communication network (e.g., the WCDMA network).

FIG. 2 shows a diagram of a configuration of a broadcast/multicast service center (BM-SC), which is a network node for performing the MBMS control function, according to an exemplary embodiment of the present invention.

FIG. 3 shows a flowchart for representing a broadcast/multicast service session start and stop process in the MB-SC according to the exemplary embodiment of the present invention.

FIG. 4 shows a flowchart for representing a session start and stop process and a content control process for the MBMS in a configuration for transmitting the contents by using the internal CP of the BM-SC according to the exemplary embodiment of the present invention.

FIG. 5 shows a flowchart for representing the session start and stop process and the content control process for the MBMS in a configuration for transmitting the contents by using the external CP of the BM-SC 400 according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

When it is described that an element is coupled to another element, the element may be directly coupled to the other element or coupled to the other element through a third element.

In addition, the word “module” will be understood to indicate a unit for processing a predetermined function or operation, which may be realized by hardware, software, or a combination thereof.

A mobile communication network (e.g., a wideband code division multiple access (WCDMA) network) supporting a multimedia broadcast/multicast service (MBMS) according to an exemplary embodiment of the present invention will now be described.

In the WCDMA network, when the MBMS is initially transmitted, a proxy node of a broadcast multicast service center (BM-SC) determines whether there is a user terminal using the MBMS, and determines whether a packet for the corresponding MBMS is transmitted.

When the user terminal using a predetermined MBMS leaves a service area (SA) or requests a service stop, the BM-SC that is an MBMS control node receives user join information and stops transmitting contents for the MBMS service so that no data packets are generated. Therefore, unnecessary traffic packets are not generated and an overload is prevented in the mobile communication network and the BM-SC. A method for requesting the MBMS service by a new user terminal and transmitting a packet of the ongoing MBMS service to authorized user terminals returning to the original SA is provided in the exemplary embodiment of the present invention.

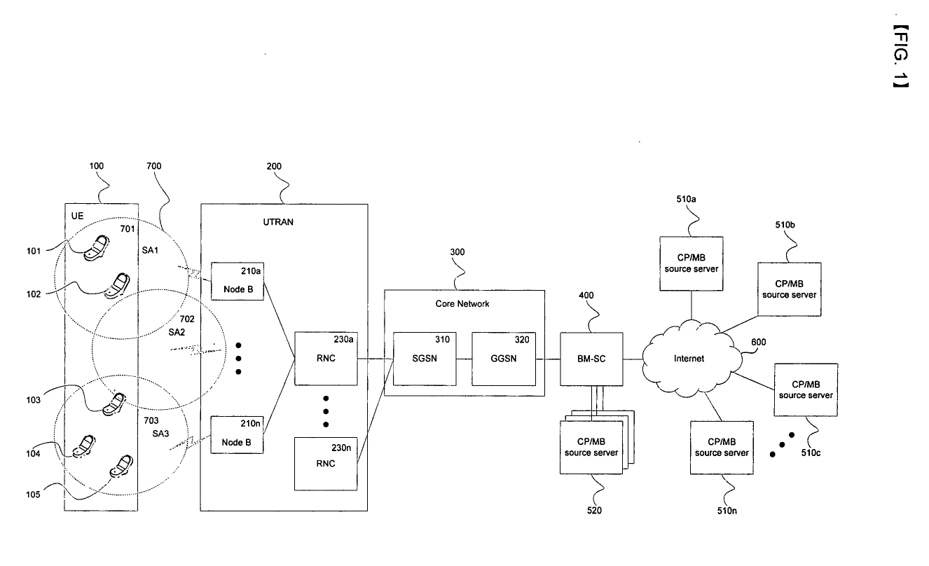

FIG. 1 shows a schematic diagram of a configuration of a system for providing the MBMS based on a 3^{rd} generation partnership project (3GPP) mobile communication network (e.g., the WCDMA network).

In FIG. 1, there are service areas (SA) providing the respective MBMSs to a plurality of user terminals according to service types. The service areas will be referred to as broadcast/multicast service areas (SA) 700.

The service area (SA) to which the MBMS is applied may have various sizes including a cell area size, a Node B area size, a radio network controller (RNC) coverage area size, a serving general packet radio service support node (SGSN) area size, and a gateway general packet radio service support node (GGSN) area size, and the respective service areas may be overlapped with each other.

In a case of multicast service, the respective service areas 701 to 703 may provide respective MBMSs, and user terminals (UE) 101 and 102 that are registered to receive the MBMS in the corresponding service area (SA1) 701 may receive the corresponding MBMS.

In a case of broadcast service, the user terminals 101 to 105 in the service areas (SA) may receive the MBMS when the user terminals 101 to 105 are set to receive a broadcast channel.

To receive a multicast service having a predetermined Internet protocol (IP) address, the user terminals (UE) 101 to 105 transmit an Internet group management protocol (IGMP) message in a case of the IPv4 system, and transmit a Join message based on a multicast listener discovery (MLD) in a case of the IPv6 system.

The GGSN in the 3GPP system receives the Join message, and performs a UE activation process to receive the MBMS, along with the BM-SC. In addition, when a predetermined user terminal finishes the MBMS, the user terminal transmits the IGMP message or an MLD Leave message to the GGSN as a UE deactivation process. The GGSN triggers the IGMP message or the MLD Leave message to perform the UE deactivation process along with the BM-SC. When the MBMS is started by a corresponding scheduler of the BM-SC after the predetermined user terminal is registered in the MBMS as described above, the user terminal receives broadcast content data.

However, the user terminal receives the MBMS without any service registration when it is configured to receive a broadcast service in the case of broadcast service. Then, the BM-SC starts the MBMS according to a start time of the MBMS managed in the system, performs an MBMS session establishment process started by a service schedule of the BM-SC to communicate with a core network (CN), a radio network controller (RNC), and the user terminal (UE) in the 3GPP network, and performs a session release process of the session established when the corresponding service is finished.

The mobile communication network (e.g., the WCDMA network) includes the user terminals (UE) 100 for receiving the broadcast/multicast multimedia content packet, a universal mobile telecommunications network terrestrial radio access network (UTRAN) 200 including a plurality of Node Bs 210a to 210n for managing the plurality of user terminals and a plurality of RNCs 230a to 230n for managing the plurality of Node Bs 210a to 210n, and the core network (CN) 300 including a plurality of GGSNs 320 connected to the plurality of SGSNs for providing packet services. In the mobile communication network (e.g., the WCDMA network), a content packet transmission control system for the MBMS includes the BM-SC 400 and at least one content provider (CP)/multicast broadcast (MB) source server 510a to 510n and 520.

The BM-SC 400 for performing an inter-working operation with the GGSN 320 of the mobile communication network (e.g., the WCDMA network) controls and manages the MBMS so that contents may be broadcasted/multicasted to the plurality of user terminals (UE) 101 to 105 that are joined to a multicast session and registered to the MBMS through a distribution tree formed by below level nodes of the GGSN 320.

According to a broadcasting schedule for each MBMS, the CP/MB source servers 510a to 510n and 520 provide broadcast/multicast service contents, as an internal content provider (CP) and/or an external CP.

The WCDMA network includes the user terminal (UE) 100, the UTRAN 200, the core network (CN) 300, the BM-SC 400 for performing an MBMS control operation, and the CP/MB source servers 520 and 510a to 510n that are connected to the BM-SC 400 or to the Internet network 600 to provide multimedia contents for the MBMS.

The UTRAN 200 includes the plurality of RNCs 230a to 230n, and the plurality of Node Bs 210a to 210n that are managed by the RNCs 230a to 230n.

The Node Bs 210a to 210n receive uplink signals that are transmitted from the plurality of user terminals (UE) 101 to 105 on a physical layer level, and transmit downlink signals to the user terminal (UE) 100. That is, the Node Bs 210a to 210n transmit/receive signals to/from the user terminal (UE) 100, and function as access points for connecting the user terminal (UE) 100 to the UTRAN 200.

Since the Node Bs 210a to 210n manage radio resources of each cell, they communicate with the user terminals (UE) 100 in the corresponding cell through a radio channel.

The RNCs 230a to 230n allocate and manage the radio resources for the plurality of Node Bs 210a to 210n, and function as the access points for connecting the Node Bs 210a to 210n to the CN 300.

The CN 300 includes at least one SGSN 310 and at least one GGSN 320.

The RNCs 230a to 230n are connected to the SGSN 310 of the CN 300.

The SGSN 310 that is connected to the GGSN 320 manages mobile communication terminal mobility, and selectively transmits data for MBMS-related services to a predetermined RNC.

The GGSN 320 functions as a gateway for performing an inter-working operation with the Internet or an external packet network. The GGSN 320 is connected to the external Internet network 600 through the BM-SC 400.

The BM-SC 400 performs the MBMS control operation, and the BM-SC 400 is required to be provided as a function of the WCDMA system to provide the MBMS. The BM-SC 400 for managing and controlling the MBMS transmits service information to the user terminal.

The BM-SC 400 provides functions for managing the MBMS subscriber and service information, applying the MBMS bearer service in the mobile communication network, starting the service, scheduling the MBMS information transmission, and transmitting the MBMS information.

To provide the MBMS to the user terminals (UE) 101 to 105, the BM-SC 400 is connected to the GGSN 320 which is the access point of a packet transmission network of the WCDMA network.

The BM-SC 400 and the GGSN 320 use an Internet protocol (IP) interface when they are connected to the external Internet network 600.

The BM-SC 400 functions as an entry point for the CP/MB source servers 510a to 510n and 520 to transmit the MBMS information, and it may function as a CP.

The CP includes an application function for transmitting the contents. The MB source server stores the only contents as a storage unit or a file transfer protocol (FTP) server, for example.

The CP/MB source servers 510a to 510n and 520 transmit the broadcast contents to the plurality of user terminals UE according to an application of the MBMS provided from the BM-SC 400 or other content providers.

The CP/MB source servers 510a to 510n and 520 may perform communications by using nodes of the public Internet 600.

When registering a request for receiving the MBMS to the BM-SC 400, the user terminal (UE) 100 receives the corresponding MBMS contents from the BM-SC 400 when a predetermined MBMS is started.

According to the MBMS control operation, the BM-SC 400 transmits the MBMS contents from the CP/MB source servers 510a to 510n and 520 to the plurality of user terminals 101 and 102 in the corresponding service area (SA1) 701 through the GGSN 320, the SGSN 310, the RNC 230a to 230n, and the Node Bs 210a to 210n, by using a public channel that is used in the corresponding service area SA1.

In this case, the BM-SC 400 transmits the corresponding contents to the plurality of GGSNs 320 supporting the user terminals waiting to receive the corresponding MBMS service.

The GGSN 320 transmits the corresponding contents to the plurality of SGSNs 310 supporting the plurality of user terminals (UE) 101 and 102 of the corresponding service area (SA1) 701.

The SGSN 310 transmits the contents to the plurality of RNCs 230a to 230n, and the corresponding RCN transmits the contents to the plurality of Node Bs 210a to 210n.

Finally, the Node Bs 210a to 210n transmit the contents to the user terminals UE 101 and 102 through the public channel used in the corresponding service area (SA1) 701.

According to a broadcasting schedule of each service, in the MBMS, the contents are transmitted from the CP/MB source servers 510a to 510n and 520 to authorized user terminals (UE) 101 and 102 that are requesting the MBMS, through the distribution tree formed by the below level nodes of the GGSN by the control of the BM-SC 400.

Accordingly, although there is no user terminal (UE) waiting to receive a predetermined MBMS, the internal CP/MB source server 520 or the external CP/MB source servers 510a to 510n of the BM-SC 400 transmit data packets to the user terminal (UE) by broadcasting/multicasting the broadcast contents when the MBMS is started.

The data packets are transmitted from CP/MB source to right before the GGSN 320 through the BM-SC 400 along an MBMS packet transmission path.

When determining that there is no valid GGSN in the corresponding distribution tree in a step for transmitting the data packets to the GGSN 320, the BM-SC 400 stops transmitting the contents to the below level nodes of the GGSN.

While the BM-SC 400 may be formed by a plurality of physical nodes to manage the MBMS in the mobile communication network providing the various types of MBMSs, the access point of the GGSN used as a data packet transmission network is maintained as one node.

The BM-SC 400 is connected to the GGSN of the mobile communication network through one proxy node 210, determines whether there is an MBMS service user terminal in a step for generating the MBMS contents to provide a predetermined multicast service, and determines to transmit the packets for the corresponding MBMS.

Since the BM-SC 400 reduces broadcast content traffic for the MBMS that is unnecessarily concentrated on the proxy node 210, and broadcasts/multicasts the resources of the BM-SC 400 to an actual MBMS service user terminal, a stable MBMS is provided.

Specifically, in the exemplary embodiment of the present invention, the content packet of the MBMS may be generated by the internal CP/MB source server and the external CP/MB source server of the BM-SC 400.

When the MBMS content packet is generated by the external CP, the external CP and the BM-SC 400 are connected by the public Internet.

Therefore, the BM-SC 400 minimizes the amount of packets that are unnecessarily transmitted between the CP/MB source servers 510a to 510n and 520, and efficiently transmits the traffic for the MBMS. In addition, since the concentration of traffic packets on the network having the BM-SC 400 is prevented and the packets are not unnecessarily transmitted (i.e., the packets are not transmitted when there is no receiving terminal), the MBMS may be provided in a stable mobile communication network state.

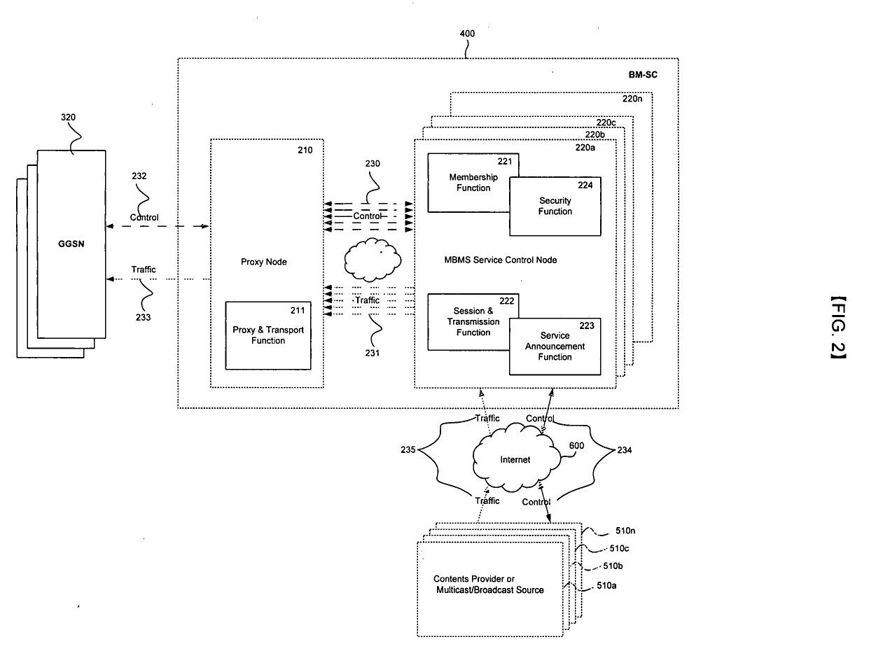

FIG. 2 shows a diagram of a configuration of the BM-SC, which is a network node for performing the MBMS control function, according to the exemplary embodiment of the present invention.

The BM-SC 400 that is connected to the GGSN 320 transmits the contents to constituent elements of the 3GPP mobile communication system, which are shown on the left side of the GGSN in FIGS. 1 and 2.

Interfaces of the GGSN 320 and the BM-SC 400 include a control interface 230 for exchanging a control message for managing the MBMS, and a traffic interface 231 for transmitting the contents to the plurality of user terminals (UE) 100 that are authorized for the actual MBMS through a packet traffic path.

The BM-SC 400 may include a plurality of network nodes 220a to 220n to efficiently provide the MBMS.

In the above configuration, the BM-SC 400 may include separate nodes for performing respective functions, or it may include various nodes having the same function to respectively perform the different MBMSs.

When the BM-SC 400 includes the various nodes, the interfaces between the BM-SC 400 and the GGSN 320 are executed by the proxy node 210.

The proxy node 210 includes a proxy & transport function 211 for transmitting the actual contents.

The BM-SC 400 performs an inter-working operation with the GGSN 400 through the one proxy node interface, regardless of the physical configuration of the BM-SC 400 for controlling the MBMS through the constituent elements of the 3GPP system that are shown on the left side of the GGSN 320 in FIGS. 1 and 2.

Accordingly, the interfaces (control and traffic) between the BM-SC 400 and the GGSN 320 are connected to the interfaces between the proxy node 210 and the GGSN 320.

In addition, interfaces between the proxy node 210 and the respective nodes 220a to 220n forming the BM-SC 400 include control and traffic interfaces in a like manner of the interfaces between the proxy node 210 and the GGSN 320.

That is, the interfaces between the proxy node 210 and the GGSN 320 include a control interface 232 for exchanging the control message for managing the MBMS, and a packet traffic interface 233 for transmitting the contents to the user terminal (UE) 100 that is registered to the MBMS.

The BM-SC 400 performs the inter-working operation with the public Internet 600 and external content providers (CP) or multicast broadcast (MB) source servers 510a to 510n, to provide the MBMS. In this case, interfaces between the BM-SC 400 and the CP/MB source servers 510a to 510n include a control message interface 234 for performing the MBMS control operation and a traffic interface 235 for transmitting the MBMS contents.

To provide the MBMS, the BM-SC 400 includes the proxy transport function 211, a membership function 221, a session and transmission function 222, a service announcement function 223, and security function 224 nodes.

The membership function 221 authenticates the user terminal (UE) that requests activation of the MBMS, and manages subscriber information of the MBMS users. In addition, the membership function 221 may generate accounting information in relation to the use of the MBMS, provide an MBMS bearer service function, and provide a user service function such as a membership management function.

The membership function 221 of the BM-SC 400 is also used for authorization of the subscriber information.

The session and transmission function 222 performs a scheduling function of MBMS session transmission and MBMS session retransmission, generates a session identifier, and provides transport information including a quality of service (QoS) and an MBMS service area to the GGSN 320. In addition, the session and transmission function 222 may start and stop MBMS bearer resources when MBMS data are transmitted, and may transmit the MBMS data.

The session and transmission function 222 is required to use a specified MBMS codec or a forward error correction (FEC) method for efficiently correcting errors, and to receive the contents according to an authorized process for authenticating external resources. Further, the session and transmission function 222 triggers the bearer level functions when the MBMS sessions are scheduled to perform the user level service.

The service announcement function 223 announces the MBMSs. The service announcement function 223 provides media specifications (e.g., video and audio encoding types) describing information on media that should be distributed by the MBMS user service, to the user terminal (UE) 100. The service announcement function 223 also provides MBMS session specifications (e.g., a multicast service identifier, an address method, and a transmission time) describing information on the MBMS session composed the MBMS user service to the user terminal (UE) 100.

The service announcement function is accomplished by several methods as follows.
MBMS bearer capability that informs the MBMS user service.
PUSH (WAP push) method.
URL (WAP, HTTP).
SMS (point-to-point).
SMS-CB (Cell Broadcast).

To provide the MBMS service data, the MBMS security function 224 for ensuring integrity and security of the MBMS data provides functions as follows.

\textcircled{1} User Authentication and Authorization.

The user terminal (UE) 100 is authorized and authorized by the MBMS security function 224 of the BM-SC 400, and the authorized user terminal is then able to participate in the MBMS user service.

\textcircled{2} Key Derivation, Management, and Distribution.

In an arbitrary MBMS user service, encoding/decoding keys for ensuring the transmitted data are required to be regularly varied so as to verify integrity of the corresponding keys. Accordingly, it is guaranteed that only the appropriate user terminal may have access to the data in the MBMS. Specifically, when new keys are frequently provided to a user, the user is interrupted by an attacker that provides the MBMS key to another user who intends to access the data in the MBMS.

The BM-SC 400 is required to distribute the MBMS keys to the users using the terminals. When it has no decoding key for decoding the data, the user terminal (UE) 100 may request the decoding key from the MBMS security function 224 of the BM-SC.

The user terminal requesting the decoding key to the BM-SC 400 uses a new decoding key. Therefore, an additional process for managing and distributing the encoding/decoding key is provided.

\textcircled{3} Protection of the Transmitted Traffic.

To ensure integrity and security of the transmitted MBMS data, it is required to protect information on the transmitted traffic for the predetermined MBMS according to sensitivity of the transmitted data. The information protection is applied to the BM-SC 400 and the user terminals (UE) 100 in a point-to-point manner, and in the information protection, a symmetric key that is shared between the BM-SC 400 and the user terminals (UE) that are connected to the current corresponding MBMS is used.

Various information protection methods are actually provided according to a transmitted data type (e.g., media streaming application data and file download data). Processes for protecting streaming data information and download information are included in the process for managing and distributing the encoding/decoding key.

The proxy and transport function 211 performs a proxy agent function for signals transmitted/received between the GGSNs 320 and the internal functions of the BM-SC 400 that include the membership function 221 and the session and transmission function 222.

In addition, the proxy and transport function may be performed when functions of the BM-SC 400 for the respective MBMSs are provided by a plurality of separated physical network elements. Therefore, the proxy node function provides a routing function to the GGSN 320, the routing function for performing inter-working operations of various signals between the internal function of the BM-SC 400 and the GGSN 320.

In addition, the node of the BM-SC 400 may generate an accounting record so that a provider of the information on the transmitted data may perform the accounting operation, and may be performed as a mediation device for the MBMS transmitted to the GGSN 320 by the session and transmission function 222.

The proxy and transport function 211 may be divided into a proxy function for interfacing the GGSN 320 by a control signal and a transport function for processing a multicast payload.

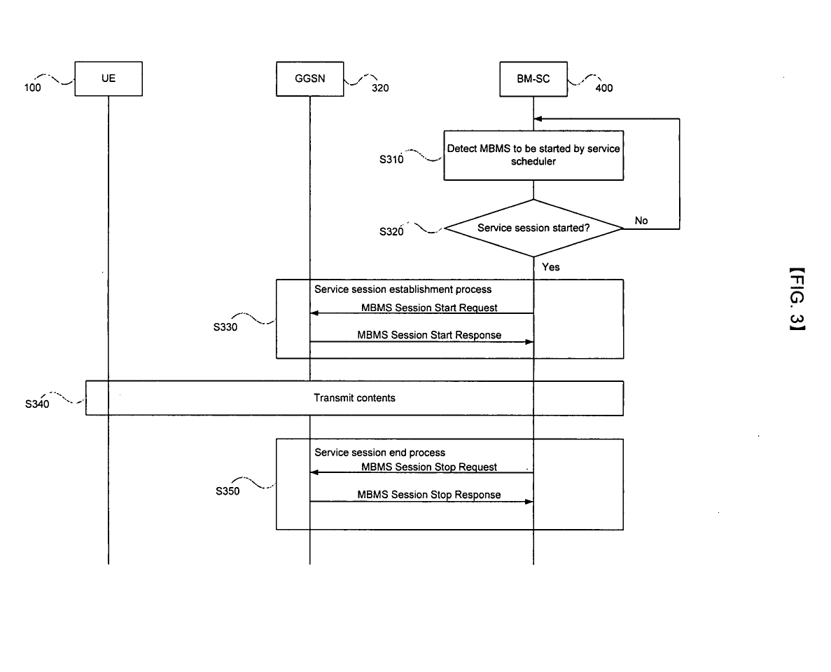

FIG. 3 shows a flowchart for representing a broadcast/multicast service session start and stop process in the BM-SC according to the exemplary embodiment of the present invention. That is, FIG. 3 shows a flowchart representing a process for starting and stopping a session service in the BM-SC 400 for the MBMS registered by a predetermined user terminal.

The BM-SC 400 detects the MBMS started by a service scheduler in step S310. When the service scheduler detects in step S320 that a predetermined MBMS service session is started, the BM-SC 400 performs a service session establishment process in step S330.

The service session establishment process is performed by transmitting an MBMS Session Start Request message from the BM-SC 400 to the GGSN 320 and by receiving an MBMS Session Start Response message from the GGSN 320 in response to the MBMS Session Start Request message.

Subsequently, in the service session establishment process, a service session is established with the user terminal authorized by the constituent elements of the WCDMA network (the 3GPP network) that are shown on the left of the GGSN 320 in FIGS. 1 and 2, and multicast service radio resources for transmitting the actual contents are allocated. Then, the BM-SC 400 transmits the contents for the corresponding MBMS to the authorized user terminal (UE) 100 through a designated path of the 3GPP network in step S340.

When the BM-SC 400 determines that the transmission of the corresponding contents are completed and it is not necessary to maintain the allocated radio resources, the service session is stopped in step S350.

A service session stop process is performed by transmitting an MBMS Session Stop Request message from the BM-SC 400 to the GGSN 320, and by transmitting an MBMS Session Stop Response message from the GGSN 320 to the BM-SC 400 in response to the MBMS Session Stop Request message. Subsequently, in the service session stop process, the resources allocated to the service session for the corresponding MBMS by the constituent elements of the 3GPP system that are shown on the left side of the GGSN 320 in FIGS. 1 and 2 are canceled.

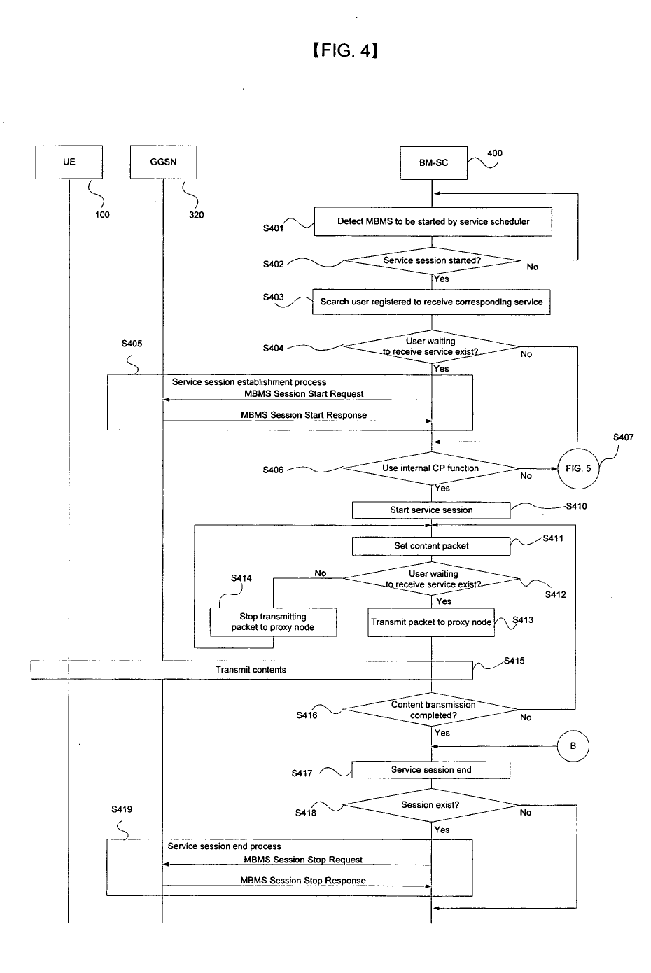

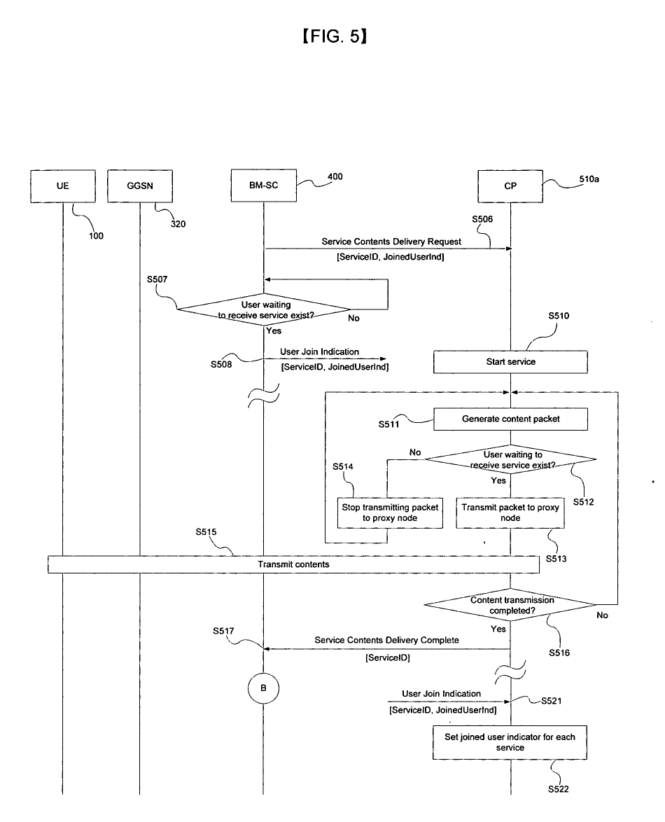

A method for performing a control process and a traffic packet process when the MBMS is started while there is no user terminal registered to use the corresponding MBMS and a method for performing the traffic packet process for the ongoing MBMS when the user terminals receiving the corresponding service leave the corresponding service area (SA) or the user terminals request to stop the service will now be described with reference to FIG. 4 and FIG. 5.

The content provider (CP) includes a function for generating the multicast traffic packet to transmit the contents for the MBMS to the user terminal (UE) 100.

The BM-SC 400 manages content providing methods for the respective services, determines whether the BM-SC 400 uses the internal CP or the external CP when inspecting the service process, and provides the MBMS.

The BM-SC 400 starts the corresponding MBMS according to the MBMS service control and a broadcasting schedule of the MBMS service provider.

FIG. 4 shows a flowchart for representing a session start and stop process and a content control process for the MBMS in a configuration for transmitting the contents by using the internal CP of the BM-SC according to the exemplary embodiment of the present invention.

The service scheduler of the BM-SC 400 searches the MBMS services that they will be started soon in step S401.

The BM-SC 400 stores and manages information for each service according to each service start time, and a system operator of the BM-SC 400 stores system information to provide the corresponding service.

When detecting in step S402 that the MBMS service session has started, the service scheduler of the BM-SC 400 searches the user terminal (UE) 100 that is registered to receive the corresponding service in step S403.

When there is no user terminal (UE) 100 waiting to receive the corresponding MBMS in step S404, the BM-SC 400 does not perform the service session establishment process. When there is a user terminal (UE) 100 which is expecting to receive the corresponding MBMS in step S404, the BM-SC 400 performs the service session establishment process to the GGSN 320 connected to the authorized user terminal (UE) in step S405.

The service session establishment process in step S405 includes a step for transmitting the MBMS Session Start Request message from the BM-SC 400 to the GGSN 320, and a step for receiving the MBMS Session Start Response message from the GGSN 320 in response to the MBMS Session Start Request message.

After performing the service session establishment process in step S405, the BM-SC 400 determines in step S406 whether a content packet generation function for the corresponding MBMS is in the internal CP or the external CP of the BM-SC 400.

When searching a content providing method for the MBMS and determining that the internal CP of the BM-SC 400 provide the contents for MBMS, the BM-SC 400 performs steps S410 to S419. When the MBMS contents are transmitted from the external CP, the BM-SC 400 performs steps shown in FIG. 5 in step S407.

The BM-SC 400 starts a service session at the MBMS start time in step S410, and the session and transmission function 222 for transmitting the contents for the service generates the content packet for the corresponding MBMS in step S411. In addition, before transmitting the generated content packet to the packet transmission network (i.e., the GGSN which is the access point of the 3GPP network), the BM-SC 400 determines in step S412 whether there is a user terminal (UE) registered to receive the current MBMS.

When there is a registered user terminal (UE), the BM-SC 400 transmits the generated content packet to the proxy node 210 performing the inter-working operation with the GGSN 320 in step S413.

The proxy node 210 of the BM-SC 400 transmits the content packet to the GGSN 320. The GGSN 320 broadcasts/multicasts the corresponding MBMS to the plurality of authorized user terminals (UE) waiting for the MBMS through the designated path in the distribution tree constructed with the entities in the 3GPP mobile communication system in step S415.

When there is no user terminal (UE) waiting to receive the corresponding MBMS, the BM-SC 400 stops transmitting the content packet to the proxy node 210 in step S414.

Steps S411 to S415 are repeatedly performed until all the MBMS contents are transmitted to the plurality of user terminals.

In addition, the session and transmission function 222 of the BM-SC 400 determines in step S412 whether there is a user terminal (UE) waiting to receive the corresponding MBMS, when the content packet is generated to transmit the proxy and transport function 211. The user terminals may request the BM-SC 400 to transmit an ongoing MBMS. When receiving the MBMS receiving request from the authorized user terminal, the BM-SC 400 transmits the MBMS contents to the user terminal 100.

In this case, a user terminal which is coming into the service area after a MBMS service starts the transmission of its contents, in order to inform intention of the user trying to receive the contents by the ongoing MBMS performs a registration process for using a session, which is provided in a 3GPP standard, and therefore a detailed description thereof will be omitted.

The BM-SC 400 receives a registration message for using the service from the user terminal (UE) 100 at any time, registers user joining information, and stores registration information including the user join information. The step 412 is performed with reference to the registration information.

The BM-SC 400 stops the predetermined service session in step S417 when the corresponding MBMS content transmission is completed in step S416 after repeatedly performing the steps S411 to S415.

When the corresponding MBMS content transmission is completed, the BM-SC 400 determines in step S418 whether there is the predetermined session registered to receive the MBMS, in addition to the step S405. The BM-SC 400 performs an MBMS service session stop process for the corresponding user terminal in step S419 when there is a predetermined session, and removes the predetermined service session.

In the service session stop process, a step for transmitting an MBMS Session Stop Request message from the BM-SC 400 to the GGSN 320 and a step for receiving an MBMS Session Stop Response message by the BM-SC 400 from the GGSN 320 in response to the MBMS Session Stop Request message are performed.

In addition, when there is no user terminal expecting to receive the MBMS after the deregistration procedure of a user terminal is over, the BM-SC 400 updates the user join information that is used to determine whether the packet is transmitted as a user terminal waiting for the corresponding service is no more exist.

FIG. 5 shows a flowchart for representing the session start and stop process and the content control process for the MBMS in a configuration for transmitting the contents by using the external CP of the BM-SC 400 according to the exemplary embodiment of the present invention. That is, FIG. 5 shows a flowchart for describing the content transmission and control process when the BM-SC 400 provides the MBMS by using the external CP/MB source servers 510a to 510n.

When it is determined that the BM-SC 400 provides the MBMS by using external CP/MB source servers 510a to 510n in step S406 in FIG. 4, the BM-SC 400 transmits a Service Contents Delivery Request message including a corresponding MBMS identifier (a service ID) and user join information (JoinedUserInd parameter) to the corresponding external CP/MB source servers 510a, 510b, and 510c in step S506.

The BM-SC 400 determines in step S507 whether there is a user terminal waiting for the corresponding MBMS. When there is a user terminal waiting for the MBMS, the BM-SC 400 transmits a User Join Indication message including the MBMS identifier (a service ID) and the user join information (JoinedUserInd parameter) indicating that there is a user terminal waiting to receive the MBMS to the corresponding external CP/MB source server 510a in step S508.

The external CP/MB source server 510a that receives the Service Contents Delivery Request message starts the service in step S510 to transmit the corresponding MBMS contents.

The external CP/MB source server 510a generates the content packets for the corresponding service in step S511. In addition, the external CP/MB source server 510a determines in step S512 whether there is a user terminal waiting to receive the MBMS before the content packet is transmitted to the BM-SC 400 by referring to the user join information (JoinedUserInd) transmitted by the Service Contents Delivery Request message.

When there is a user terminal waiting to receive the corresponding MBMS, the external CP/MB source server 510a transmits the content packet generated in step S511 to the BM-SC 400 in step S513.

The BM-SC 400 broadcasts/multicasts the contents to the plurality of authorized user terminals (UE) waiting to receive the corresponding MBMS through the designated path in the distribution tree of the below level nodes of the GGSN 320, by the proxy and transport function 211 of the proxy node 210 performing the inter-working operation with the GGSN 320 in step S515.

When there is no user terminal waiting to receive the corresponding MBMS in step S512, the external CP/MB source server 510a stops transmitting the content packet to the proxy node 210 of the BM-SC 400 in step S514.

When the content transmission is completed in step S516 after repeatedly performing the steps S511 to S515, the external CP/MB source server 510a transmits a Service Contents Delivery Complete message including a Service ID informing of the completion of the content transmission to the BM-SC 400 in step S517.

The BM-SC 400 receiving the Service Contents Delivery Complete message performs the service session stop process in a like manner of the internal CP as shown in FIG. 4 with the steps S417 to S419.

When the BM-SC 400 receives the corresponding MBMS receiving request from a user terminal while the external CP/MB source server 510a is transmitting the corresponding MBMS contents, the BM-SC 400 transmits the User Join Indication message including the user join information to the external CP/MB source servers 510a, 510b, and 510c that perform the corresponding MBMS in step S521.

In addition, when the user terminal leaves the service area (SA) or does not want to receive the MBMS, the BM-SC 400 transmits the User Join Indication message including the user join information to the external CP/MB source servers 510a, 510b, and 510c that perform the corresponding MBMS in step S521.

In this case, the User Join Indication message transmits the corresponding service identifier (Service ID) and the user join information (JoinedUserInd parameter) indicating that the user terminal requesting to receive the corresponding MBMS is newly registered or a final user terminal leaves the MBMS in step S521.

In step S522, the external CP/MB source server 510a that receives the User Join Indication message stores the information (joined User Indicator Setting for each service) indicating that there is a user terminal waiting for the corresponding MBMS.

Before transmitting the contents from the external CP/MB source server 510a to the BM-SC 400, the BM-SC 400 refers to the stored information in step S512. After the predetermined user terminal is registered to the ongoing MBMS, the external CP/MB source server 510a transmits the content packet to the corresponding user terminal (UE) 100.

When there is a on going session when the MBMS content transmission is completed, the BM-SC 400 performs the service session stop process in cooperation with the GGSN 320 used as a content transmission path.

In addition, when there is no predetermined session when the MBMS content transmission is completed, the BM-SC 400 does not perform the service session stop process in cooperation with the GGSN 320 used as the content transmission path.

When the content packet is provided from the external CP/MB source server 510a the BM-SC 400 transmits the Service Contents Delivery Request message to the external CP/MB source server 510a in order to adds the information of the user terminal waiting for the MBMS on the previous joining information for the MBMS, and uses the MBMS when the predetermined user terminal is registered to receive the MBMS.

When the user terminal rejects the reception of the ongoing MBMS and it is removed from the list of the user terminal waiting for the corresponding service, the BM-SC 400 transmits a message to the external CP/MB source server 510a to change the user join information used to determine whether the packet is transmitted when the corresponding service contents are transmitted, so that the user join information includes no information on the user terminal waiting for the corresponding service.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, when the BM-SC for performing the MBMS controlling operation in the mobile communication is connected to the internal CP/MB Source server or the external CP/MB Source server, interruption of the traffic packets that are unnecessarily provided to the network when the corresponding packet is initially generated, make a network state stable.

In a system for providing the broadcast/multicast service in the mobile communication network, the packet is concentrated on a predetermined node since the broadcast/multicast service is transmitted through some functions of the BM-SC. A service provider starts the corresponding service at an advertised time according to characteristics of the broadcast service. When the MBMS is started and there is no user terminal waiting to receive the corresponding service, the network and the system resources for the service control operation may be protected since the BM-SC or the external CP interrupts the corresponding packets from being transmitted to the GGSN of the mobile communication network. Therefore, the BM-SC for performing the broadcast/multicast service controlling and managing operations performs all the processes, and stops transmitting the packet to the mobile communication network in the last process. The BM-SC for performing the inter-working operation with various CP/MB sources servers and receiving a large amount of content packets prevents unnecessary processes and overload of the mobile communication network. In addition, the BM-SC prevents a service process speed decrease and an overload caused by an increase of the unnecessary packets provided to the mobile communication network.

Therefore, according to the exemplary embodiment of the present invention, to support the MBMS, resources of the service control node may be protected and network congestion may be minimized since the service packet for transmitting the contents concentrated on the service control node is interrupted when the packet is generated.

What is claimed is:

1. A content packet transmission control system in a mobile communication network (a wideband code division multiple access (WCDMA) network) supporting a multimedia broadcast/multicast service (MBMS), the mobile communication network comprising a universal mobile telecommunications network terrestrial radio access network (UTRAN) having a plurality of Node Bs and a plurality of wireless network controllers (RNC), and a core network (CN) having a plurality of gateway general packet radio service support nodes (GGSN) connected to a plurality of serving gateway general packet radio service support nodes (SGSN) providing packet services, the content packet transmission control system comprising:
a broadcast/multicast service center (BM-SC) for performing an inter-working operation with the GGSN, and controlling and managing the MBMS so that MBMS service contents are broadcasted/multicasted to a plurality of user terminals through a distribution tree formed by below level nodes of the GGSN; and
a content provider (CP)/multicast broadcast (MB) source server for providing multimedia contents as an internal content provider (CP) or an external CP connected to the Internet according to a broadcasting schedule predetermined for each MBMS.

2. The content packet transmission control system of claim 1, wherein the BM-SC uses a control interface for exchanging a control message for managing the MBMS and a traffic interface used as a packet traffic path for transmitting the MBMS contents to an authorized user terminal, which are provided between the GGSN and a proxy node of the BM-SC.

3. The content packet transmission control system of claim 1, wherein the BM-SC and the CP/MB source server are connected to an internal network or the public Internet, and use a control interface for transmitting/receiving an MBMS control message and a traffic interface for transmitting the MBMS service contents.

4. The content packet transmission control system of claim 1, wherein the BM-SC comprises a membership function node in order to perform authorization procedure of the MBMS service on a user terminal requesting an MBMS activation, and managing subscriber information for an MBMS user.

5. The content packet transmission control system of claim 1, wherein the BM-SC comprises a session and transmission function node for performing a scheduling function of MBMS session transmission and retransmission, generating a session identifier (Session ID), providing transport information including a quality of service or an MBMS service area, requesting an allocation/deallocation of an MBMS bearer resource when MBMS data are transmitted, and transmitting the MBMS data.

6. The content packet transmission control system of claim 1, wherein the BM-SC comprises a service announcement function node for providing MBMS announcement information to the user terminal, the MBMS announcement information comprising media description information provided as part of MBMS user services and MBMS session specific information comprising a multicast service identifier, an address method, and a provided MBMS session.

7. The content packet transmission control system of claim 1, wherein the BM-SC comprises an MBMS security function node for authenticating/authorizing the user terminal, generating/managing/distributing an encoding/decoding key for protecting transmitted MBMS data, and protecting transmitted traffic according to data type.

8. The content packet transmission control system of claim 1, wherein the BM-SC comprises a proxy & transport function node for providing a proxy agent function, a transmitted data charging function, and a transport function for processing a multicast payload according to a signal transmitted/received between the GGSNs and functional nodes of the BM-SC.

9. A content packet transmission controlling method in a mobile communication network (a wideband code division multiple access (WCDMA) network) comprising a universal mobile telecommunications network terrestrial radio access network (UTRAN) having a plurality of Node Bs and a plurality of wireless network controllers (RNC), a core network (CN) having a plurality of gateway general packet radio service support nodes (GGSN) connected to a plurality of serving gateway general packet radio service support nodes (SGSN) providing packet services, and a broadcast/multicast service center (BM-SC) connected to the GGSN to control and manage a multimedia broadcast/multicast service (MBMS), the content packet transmission controlling method comprising:
a) determining whether there is a user terminal registered to receive the corresponding MBMS when a service scheduler of the BM-SC detects that an MBMS session at a service start time has started;
b) performing a service session establishment process through the GGSN when there is the user terminal waiting to receive the corresponding MBMS;
c) starting the MBMS session, and generating an MBMS content packet by a session and transmission function of the BM-SC;
d) transmitting the generated MBMS content packet to a proxy and transport node of the BM-SC performing an inter-working operation with the GGSN; and
e) transmitting the MBMS content packet to the GGSN by the proxy and transport node of the BM-SC, and multicasting/broadcasting the MBMS content packet to a plurality of user terminals waiting for the corresponding MBMS through a designated path on the distribution tree included the lower level nodes of the GGSN.

10. The content packet transmission controlling method of claim 9, further comprising:
f) stopping transmitting the generated content packet to a proxy node when there is no user terminal waiting to receive the corresponding MBMS based on user information; and
g) removing the MBMS session when contents transmission for the corresponding MBMS are finished

11. The content packet transmission controlling method of claim 10, further comprising
h) determining whether there is a predetermined service session when a corresponding MBMS content transmission is completed, and releasing the corresponding service session according to an MBMS session stop process when there is a predetermined service session.

12. The content packet transmission controlling method of claim 11, further comprising
i) by the BM-SC, managing user join information used for determining whether the content packet is transmitted when a predetermined user terminal registers to receive an ongoing MBMS or cancels a registration for the ongoing MBMS.

13. The content packet transmission controlling method of claim 9, wherein the BM-SC stops transmitting the corresponding service content packet based on user join information when the user terminal using the predetermined MBMS leaves a service area or requests to stop the MBMS.

14. The content packet transmission controlling method of claim 9, wherein a) comprises:
when a new user terminal requests to receive the MBMS to the BM-SC at an arbitrary time in a service area, determining whether there is the user terminal waiting for the corresponding MBMS when the BM-SC transmits the content packet;
receiving a registration message from the new user terminal on an ongoing MBMS, and register to the session of the ongoing MBMS; and
receiving the registration message and storing registration information by the BM-SC.

15. The content packet transmission controlling method of claim 9, wherein the MBMS is provided by an internal content provider.

16. A content packet transmission controlling method in a mobile communication network (a wideband code division multiple access (WCDMA) network) comprising a universal mobile telecommunications network terrestrial radio access network (UTRAN) having a plurality of Node Bs and a plurality of wireless network controllers (RNC), a core network (CN) having a plurality of gateway general packet radio service support nodes (GGSN) connected to a plurality of serving gateway general packet radio service support nodes (SGSN) providing packet services, and a broadcast/multicast service center (BM-SC) connected to the GGSN to control and manage a multimedia broadcast/multicast service (MBMS), the content packet transmission controlling method comprising;
a) determining whether there is a user terminal registered to receive the corresponding MBMS when a service scheduler of the BM-SC detects that an MBMS session at a service start time has started;
b) transmitting a service content delivery request message comprising an MBMS identifier (Service ID) and user join information (JoinedUserInd parameter) on a user terminal waiting to receive the MBMS, to an external content provider (CP); and
c) by the BM-SC, transmitting a user join indication message comprising the MBMS identifier (Service ID) and updated user join information (JoinedUserInd parameter) to the corresponding external CP when there is a new user terminal waiting to receive the MBMS.

17. The content packet transmission controlling method of claim 16, further comprising:
d) by the BM-SC, receiving a service contents delivery complete message comprising the service ID for informing completion of the content transmission from the external CP after an MBMS content packet is transmitted from the external CP by the service ID;
e) receiving the service contents delivery complete message and stopping the service session.

18. A content packet transmission controlling method in a mobile communication network (a wideband code division multiple access (WCDMA) network) comprising a universal mobile telecommunications network terrestrial radio access network (UTRAN) having a plurality of Node Bs and a plurality of wireless network controllers (RNC), a core network (CN) having a plurality of gateway general packet radio service support nodes (GGSN) connected to a plurality of serving gateway general packet radio service support nodes (SGSN) providing packet services, and a broadcast/multicast service center (BM-SC) connected to the GGSN to control and manage a multimedia broadcast/multicast service (MBMS), the content packet transmission controlling method comprising:
a) by an external CP, receiving a service content delivery request message from the BM-SC;
b) by the external CP, when there is a user terminal waiting to receive the MBMS, receiving a user join indication message comprising a service identifier (Service ID) and updated user join information (JoinedUserInd) from the BM-SC, and transmitting contents for the corresponding MBMS;
c) by the external CP, generating a content packet for the corresponding MBMS;
d) determining whether there is a user terminal waiting to receive the corresponding MBMS with reference to the user join information;
e) when there is a user terminal waiting to receive the corresponding MBMS, transmitting the generated content packet to a proxy node of the BM-SC, and broadcasting/multicasting the content packet to a plurality of user terminals waiting to receive the corresponding MBMS through the proxy node performing an inter-working operation with the GGSN; and
f) transmitting a service contents delivery complete message comprising the Service ID for informing of service transmission completion to the BM-SC.

19. The content packet transmission controlling method of claim 18, further comprising:
g) by the external CP, stopping transmission of the generated content packet to the proxy node of the BM-SC when it is determined based on the user join information that there is no user terminal waiting to receive the corresponding MBMS.

20. The content packet transmission controlling method of claim 18, further comprising:
h) by the external CP receiving the user join indication message, receiving the user join indication message comprising the service ID and the user join information indicating whether there is a user terminal waiting for the corresponding MBMS managed for each service; and
i) storing joined user information for each service by the external CP.

21. The content packet transmission controlling method of claim 18, further comprising:
j) by the external CP, managing the user join information for determining whether the content packet is transmitted when a predetermined user terminal is registered to receive an ongoing MBMS or cancels a registration for the ongoing MBMS.
